(19) United States
(12) Patent Application Publication
(10) Pub. No.: US 2025/0263127 A1
(43) Pub. Date: Aug. 21, 2025

(54) VEHICLE FRONT STRUCTURE

(71) Applicant: TOYOTA JIDOSHA KABUSHIKI KAISHA, Toyota-shi (JP)

(72) Inventor: Ryosuke FUKUI, Aichi-Ken (JP)

(73) Assignee: TOYOTA JIDOSHA KABUSHIKI KAISHA, Toyota-shi (JP)

(21) Appl. No.: 19/041,272

(22) Filed: Jan. 30, 2025

(30) Foreign Application Priority Data
Feb. 20, 2024 (JP) 2024-024061

(51) Int. Cl. B62D 25/14

(52) U.S. Cl. CPC B62D 25/145

(57) ABSTRACT

The vehicle front structure includes a dash portion disposed at the vehicle front portion and partitioning the vehicle cabin and the outside of the vehicle cabin, and a pair of right and left front pillar portions connected to both end portions of the dash portion in the vehicle width direction and extending in the vehicle vertical direction, and a die-cast main framework integrally formed therewith, an outer panel disposed outside the main framework in the vehicle width direction and configured to constitute an aesthetic surface and fastened to the main framework, an instrument panel reinforcement extending in the vehicle width direction between the pair of right and left front pillar portions in the vehicle cabin, and a linking bracket connecting the main framework and the instrument panel reinforcement.

### CROSS-REFERENCE TO RELATED APPLICATION

This application claims priority to Japanese Patent Application No. 2024-024061 filed on Feb. 20, 2024, incorporated herein by reference in its entirety.

### BACKGROUND

### 1. Technical Field

The disclosure relates to a vehicle front structure.

### 2. Description of Related Art

Japanese Unexamined Patent Application Publication No. 2008-94172 (JP 2008-94172 A) discloses a structure in which a cross car beam (instrument panel reinforcement) extending in a vehicle width direction is provided inside an instrument panel. Also, in the structure described in JP 2008-94172 A, side brackets are attached to both end portions of the cross car beam, and the cross car beam is connected to vehicle body panels via the side brackets.

### SUMMARY

However, in the structure described in JP 2008-94172 A, the both end portions of the instrument panel reinforcement are attached to the vehicle body panels formed of a rigid plate or the like, and accordingly there is a possibility that rigidity of the attachment portion cannot be sufficiently secured.

An object of the disclosure is to provide a vehicle front structure in which rigidity of an attachment portion between an instrument panel reinforcement and a vehicle body can be secured.

A vehicle front structure according to Aspect 1 includes

a main framework that is die cast and that integrally includes a dash portion disposed at a vehicle front, partitioning between inside of a vehicle cabin and outside of the vehicle cabin, and a pair of right and left front pillar portions connected to both end portions of the dash portion in a vehicle width direction and extending in a vehicle up-down direction,
an outer panel that is disposed on an outer side of the main framework in the vehicle width direction and makes up an aesthetic surface, and that is also fastened to the main framework,
an instrument panel reinforcement extending in the vehicle width direction between the right and left front pillar portions in the vehicle cabin, and
a linking bracket that links the main framework and the instrument panel reinforcement.

In the vehicle front structure according to Aspect 1, the main framework is die cast and integrally includes the dash portion and the right and left front pillar portions. Also, the outer panel that makes up an aesthetic surface is disposed on the outer side of the main framework in the vehicle width direction, and the outer panel and the main framework are fastened. Further, the instrument panel reinforcement is provided extending in the vehicle width direction between the right and left front pillar portions in the vehicle cabin, and the main framework and the instrument panel reinforcement are linked by the linking bracket. Thus, by linking the instrument panel reinforcement to the main framework that is die cast, the rigidity of the attachment portion can be secured, in comparison with a structure connected to a steel plate or the like.

In the vehicle front structure according to Aspect 2, in Aspect 1,

the instrument panel reinforcement and the linking bracket are fastened in a vehicle front-rear direction, and
the main framework and the linking bracket are fastened in the vehicle width direction.

In the vehicle front structure according to Aspect 2, fastening directions of the instrument panel reinforcement and the linking bracket, and of the main framework and the linking bracket, are different from each other. Accordingly, attachment strength can be maintained satisfactorily with respect to both vibrations in the vehicle front-rear direction and vibrations in the vehicle width direction.

In the vehicle front structure according to Aspect 3, in Aspect 1,

the main framework, the outer panel, and the linking bracket are fastened together by fasteners.

In the vehicle front structure according to Aspect 3, the number of parts can be reduced due to reducing the number of fasteners by fastening the three parts together, in comparison with a case in which the respective parts are individually fastened to each other. Further, by fastening together, the main framework can be clamped between the outer panel and the linking bracket.

In the vehicle front structure according to Aspect 4, in Aspect 3,

a collar member is disposed between the outer panel and the linking bracket.

In the vehicle front structure according to Aspect 4, distance between the outer panel and the linking bracket can be maintained constant by the collar member.

In the vehicle front structure according to Aspect 5, in any one of Aspects 1 to 4,

the main framework includes a front side member portion extending to a forward side in a vehicle from the dash portion.

In the vehicle front structure according to Aspect 5, the main framework includes the front side member portion, and accordingly the number of parts can be reduced in comparison with a structure configured including a front side member separate from a main framework.

As described above, according to the vehicle front structure of the disclosure, rigidity of the attachment portion between the instrument panel reinforcement and a vehicle body can be secured.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a perspective view illustrating a part of a vehicle front structure according to an embodiment;

FIG. 2 is an enlarged cross-sectional view of a main part of the main framework, the instrument panel reinforcement, and the linking brackets according to the embodiment; and

FIG. 3 is an enlarged cross-sectional view of a main part illustrating a fastened state of a main framework, an instrument panel reinforcement, and a linking bracket in a modification example.

### DETAILED DESCRIPTION OF EMBODIMENTS

A vehicle front structure according to an embodiment will be described with reference to the drawings.

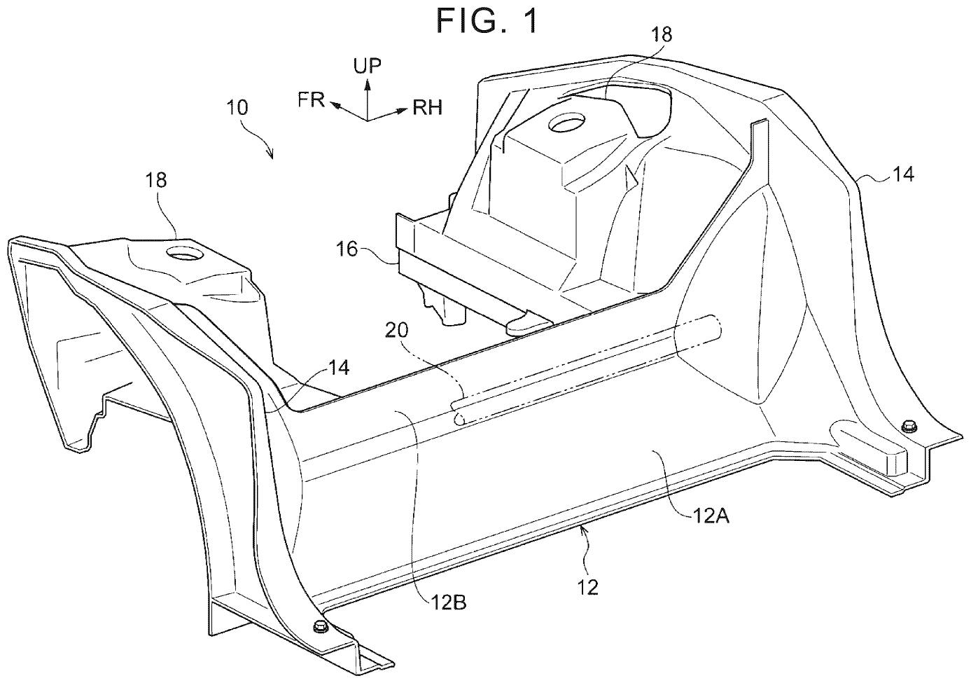

FIG. 1 is a perspective view illustrating a part of a vehicle front structure according to an embodiment. Note that the arrow FR, the arrow UP, and the arrow RH in the drawing indicate the vehicle front direction, the vehicle upper direction, and the vehicle right direction in the vehicle, respectively. In the following description, when the front, rear, up, down, and right and left directions are used without special mention, the front and rear directions in the vehicle front-rear direction, the up and down directions in the vehicle up-down direction, and the right and left directions in the vehicle left-right direction (width direction) are respectively indicated.

As shown in FIG. 1, the main framework 10 constituting the vehicle front structure includes a dash portion 12, a front pillar portion 14, a front side member portion 16, and a suspension tower portion 18. Further, the main framework 10 is made of die cast, and the dash portion 12, the front pillar portion 14, the front side member portion 16, and the suspension tower portion 18 are integrally formed by casting.

The dash portion 12 is disposed in the vehicle front portion and partitions the vehicle cabin and the outside of the vehicle cabin, and a surface of the lower portion of the dash portion 12 on the vehicle rear side is an inclined surface 12A in which the upper side is located on the vehicle front side from the lower side. The inclined surface 12A is located below the instrument panel (not shown).

A surface of the upper portion of the dash portion 12 on the vehicle rear side extends substantially perpendicularly in the vehicle up-down direction and the vehicle width direction.

Front pillar portions 14 are connected to both end portions of the dash portion 12 in the vehicle width direction, and the pair of right and left front pillar portions 14 extend in the vehicle vertical direction. Specifically, a lower portion of the front pillar portion 14 extends in the vehicle front-rear direction, and a rocker of a skeleton member (not shown) is connected to a rear end portion of the front pillar portion 14.

The front pillar portion 14 extends obliquely from the rear end portion toward the vehicle upper side and the vehicle front side, and is configured to transmit a load acting on the main framework 10 in the vehicle vertical direction.

A pair of right and left front side member portions 16 extend from both end portions in the vehicle width direction of the dash portion 12 toward the vehicle front side. The front side member portion 16 extends in the vehicle front-rear direction and is configured to transmit a load input from the vehicle front side to the vehicle rear side.

Suspension tower portions 18 are provided on the vehicle width direction outer sides of the pair of right and left front side member portions 16, respectively. The suspension tower portion 18 is positioned on the vehicle upper side relative to the front side member portion 16, and is configured to be capable of supporting a suspension (not shown).

Here, an instrument panel reinforcement 20 extending in the vehicle width direction is provided on the vehicle cabin side of the dash portion 12. The instrument panel reinforcement 20 is a substantially cylindrical member installed between the right and left front pillar portions 14, and the instrument panel reinforcement 20 is configured to support a steering shaft (not shown), an air conditioner, and the like.

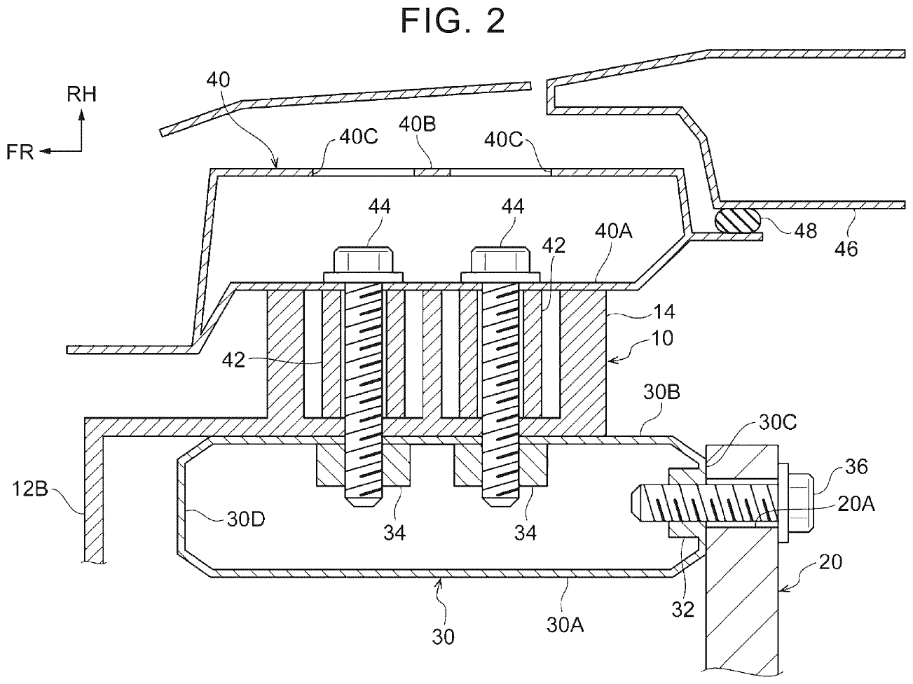

FIG. 2 is an enlarged cross-sectional view illustrating a state in which the main framework 10, the instrument panel reinforcement 20, and the linking bracket 30 are fastened in the embodiment. As shown in FIG. 2, an outer panel 40 is disposed on the vehicle width direction outer side of the main framework 10.

The outer panel 40 constitutes a part of the aesthetic surface of the vehicle, and includes an inner wall portion 40A located on the inner side in the vehicle width direction in a plan view, and an outer wall portion 40B located on the outer side in the vehicle width direction, and is configured in a closed cross-section shape. The outer panel 40 may be integrally formed by extrusion or the like, or may be formed by superposing two rigid plates.

A flange extending toward the vehicle rear side is formed at a rear end portion of the outer panel 40, and a side door 46 is disposed on the vehicle width direction outer side of the flange via a sealing material 48.

The main framework 10 is fixed to the inner wall portion 40A of the outer panel 40. Specifically, a plurality of ribs extending outward in the vehicle width direction are formed on a surface of the front pillar portion 14 of the main framework 10 on the outside in the vehicle width direction, and the ribs are fixed to the outer panel 40 in a state of being abutted against the outer panel 40.

The method of fixing the outer panel 40 and the main framework 10 is not particularly limited. For example, it may be mechanically fixed using bolts, rivets, or the like. Further, for example, it may be fixed using an adhesive or the like, or it may be fixed by a joining means such as welding. In the present embodiment, the front pillar portion 14 of the main framework 10 and the inner wall portion 40A of the outer panel 40 are temporarily fixed by an adhesive material (not shown).

Here, the instrument panel reinforcement 20 and the main framework 10 are connected by a linking bracket 30.

The linking bracket 30 is formed of metal in a closed cross-sectional shape. In the present embodiment, the linking bracket 30 includes a bracket inner wall portion 30A located on the vehicle width direction inner side and a bracket outer wall portion 30B located on the vehicle width direction outer side. The linking bracket 30 includes a bracket rear wall portion 30C and a bracket front wall portion 30D. The bracket rear wall portion 30C connects the rear end of the bracket inner wall portion 30A and the rear end of the bracket outer wall portion 30B. The bracket front wall portion 30D connects the front end of the bracket inner wall portion 30A and the front end of the bracket outer wall portion 30B.

A first weld nut 32 is provided inside the linking bracket 30. The first weld nut 32 is provided on the inner surface of the bracket-rear-wall portion 30C, and the first bolt 36 is screwed. Here, a bolt hole 20A is formed at an outer end portion of the instrument panel reinforcement 20 in the vehicle width-direction, and the bolt 36 is inserted into the bolt hole 20A and screwed into the first weld nut 32. As described above, the instrument panel reinforcement 20 and the linking bracket 30 are fastened in the vehicle front-rear direction by inserting the bolt 36 from the vehicle rear side and screwing into the first weld nut 32.

A second weld nut 34 is provided inside the linking bracket 30. Two second weld nuts 34 are provided on the inner surface of the bracket-outer-wall portion 30B, and are spaced apart from each other in the vehicle-front-rear direction. A bolt 44 as a fastening portion is screwed to each of the two second weld nuts 34.

A working hole 40C into which the bolts 44 can be inserted is formed in the outer wall portion 40B of the outer panel 40. A bolt 44 is inserted from the working hole 40C, and the bolt 44 is inserted into the inner wall portion 40A of the outer panel 40 and the front pillar portion 14, and is screwed into the second weld nut 34. As described above, the main framework 10 and the linking bracket 30 are fastened to each other in the vehicle width direction by the bolts 44 and the second weld nuts 34.

In particular, in the present embodiment, the main framework 10, the outer panel 40, and the linking bracket 30 are fastened together by the bolts 44.

Here, a collar member 42 is provided between the outer panel 40 and the linking bracket 30. The collar member 42 is disposed at the insertion position of the two bolts 44, and is disposed between the ribs arranged in the vehicle front-rear direction in the front pillar portion 14 of the main framework 10. The collar member 42 is in contact with the outer panel 40 and the linking bracket 30, respectively.

### Operations

Next, the operation of the vehicle front structure according to the present embodiment will be described.

In the vehicle front structure according to the present embodiment, as shown in FIG. 1, the die-cast main framework 10 is integrally formed including a dash portion 12 and a pair of right and left front pillar portions 14. Further, since the main framework 10 includes the front side member portion 16, the number of parts can be reduced as compared with a structure including a front side member separate from the main framework 10.

Further, in the vehicle front structure of the present embodiment, the instrument panel reinforcement 20 extending in the vehicle width direction between the pair of right and left front pillar portions 14 is provided in the vehicle cabin. Further, as shown in FIG. 2, an outer panel 40 is provided on the vehicle width direction outer side of the main framework 10, and the outer panel 40 and the main framework 10 are fastened.

Furthermore, the main framework 10 and the instrument panel reinforcement 20 are connected by a linking bracket 30. In this manner, the instrument panel reinforcement 20 is connected to the die-cast main framework 10. As a result, the rigidity of the attachment portion between the instrument panel reinforcement 20 and the vehicle body can be ensured as compared with a structure in which the instrument panel reinforcement is connected to a steel sheet or the like.

Further, in the vehicle front structure of the present embodiment, the fastening direction of the instrument panel reinforcement 20 and the linking bracket 30 is different from the fastening direction of the main framework 10 and the linking bracket 30. Specifically, the instrument panel reinforcement 20 and the linking bracket 30 are fastened in the vehicle front-rear direction, and the main framework 10 and the linking bracket 30 are fastened in the vehicle width direction. Accordingly, attachment strength can be maintained satisfactorily with respect to both vibrations in the vehicle front-rear direction and vibrations in the vehicle width direction.

In particular, in the present embodiment, since the three members of the main framework 10, the outer panel 40, and the linking bracket 30 are fastened together, the number of parts can be reduced by reducing the number of bolts that are fasteners as compared with the case where the respective parts are fastened together. Further, by fastening together, the main framework 10 can be sandwiched between the outer panel 40 and the linking bracket 30.

Further, in the present embodiment, since the collar member 42 is provided between the main framework 10 and the outer panel 40, the distance between the outer panel 40 and the linking bracket 30 can be maintained constant by the collar member 42.

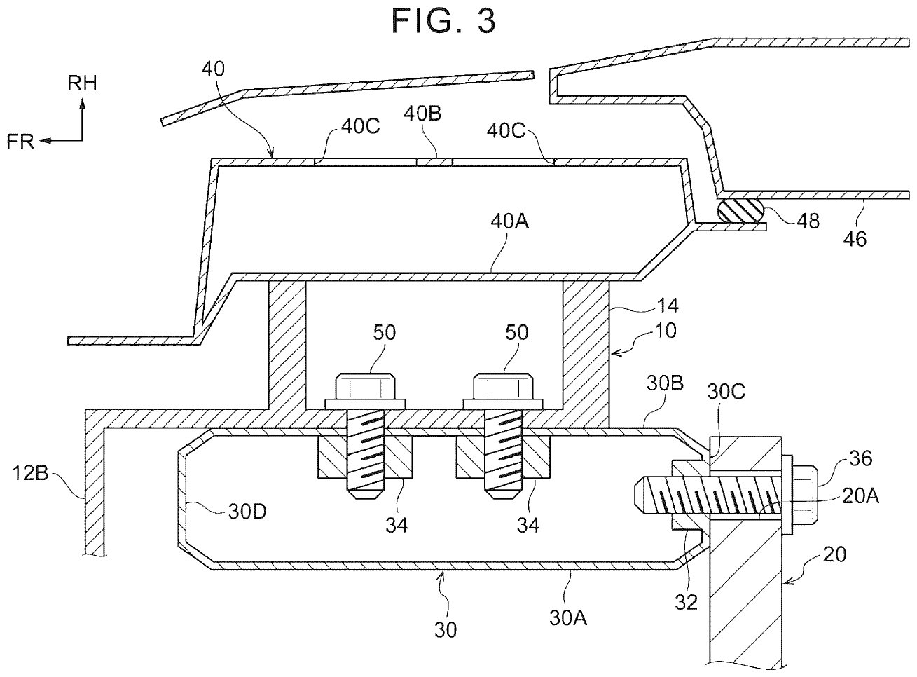

In the present embodiment, the collar member 42 is provided between the main framework 10 and the outer panel 40, but the present disclosure is not limited thereto. For example, as in the modification shown in FIG. 3, a structure without the collar member 42 may be employed.

### Modifications

FIG. 3 is an enlarged cross-sectional view illustrating a state in which the main framework 10, the instrument panel reinforcement 20, and the linking bracket 30 are fastened in a modification example.

As shown in FIG. 3, in the vehicle front structure according to the present modification, the instrument panel reinforcement 20 and the linking bracket 30 are mechanically fastened by the bolt 36 and the first weld nut 32 as in the embodiment.

A bolt 50 different from the embodiment is screwed to the second weld nut 34 provided in the linking bracket 30. The bolt 50 has an axial length shorter than that of the bolt 44 of the embodiment, and the head portion of the bolt 50 abuts on an outer surface of the front pillar portion 14 of the main framework 10 in the vehicle width direction. Therefore, in the present modification, the two members of the main framework 10 and the linking bracket 30 are fastened by the bolt 50 and the second weld nut 34.

The main framework 10 and the outer panel 40 are fixed by other means. For example, it may be fastened mechanically by a bolt or rivet or the like separate from the bolt 50 may be fixed by an adhesive material or the like. Further, it may be joined by welding or the like.

Although the vehicle front structure according to the embodiment and the modification has been described above, it is needless to say that the vehicle front structure can be implemented in various forms without departing from the gist of the present disclosure. For example, in the above-described embodiment and modification, as shown in FIGS. 2 and 3, the linking bracket 30 is a closed cross-sectional structure of a substantially rectangular shape in a closed cross-sectional view, but the present disclosure is not limited thereto, and other shapes may be used.

Further, in the above-described embodiment and modification examples, the fastening direction between the main framework 10 and the linking bracket 30 and the fastening direction between the instrument panel reinforcement 20 and the linking bracket 30 are different from each other, but the present disclosure is not limited thereto. For example, the instrument panel reinforcement 20 and the linking bracket 30 may be fastened in the vehicle width direction.

Further, in the above-described embodiment, the instrument panel reinforcement 20 and the linking bracket 30 are fastened by one bolt 36, but the present disclosure is not limited thereto, and the position and the number of bolts are not particularly limited. For example, the instrument panel reinforcement 20 and the linking bracket 30 may be fastened by two or more bolts and a weld nut.

Further, in the above embodiment, the main framework 10 and the linking bracket 30 are fastened by two bolts 44, but the present disclosure is not limited thereto, and the position and the number of bolts are not particularly limited. For example, the main framework 10 and the linking bracket 30 may be fastened by three or more bolts and a weld nut, or a combination of a bolt and a rivet may be fixed.

With respect to the above embodiments, the following supplementary notes are disclosed.

### Appendix 1

A vehicle front structure including a main framework that is die cast and that integrally includes a dash portion disposed at a vehicle front, partitioning between inside of a vehicle cabin and outside of the vehicle cabin, and a pair of right and left front pillar portions connected to both end portions of the dash portion in a vehicle width direction and extending in a vehicle up-down direction,
an outer panel that is disposed on an outer side of the main framework in the vehicle width direction and makes up an aesthetic surface, and that is also fastened to the main framework,
an instrument panel reinforcement extending in the vehicle width direction between the right and left front pillar portions in the vehicle cabin, and
a linking bracket connecting the main framework and the instrument panel reinforcement.

### Appendix 2

The instrument panel reinforcement and the linking bracket are fastened in a vehicle front-rear direction, and
The vehicle front structure according to Appendix 1, wherein the main framework and the linking bracket are fastened in a vehicle width direction.

### Appendix 3

The vehicle front structure according to Appendix 1 or 2, wherein the main framework, the outer panel, and the linking bracket are fastened together by fasteners.

### Appendix 4

The vehicle front structure according to any one of claims 1 to 3, wherein a collar member is provided between the outer panel and the linking bracket.

### Appendix 5

The vehicle front structure according to any one of claims 1 to 4, wherein the main framework includes a front side member portion extending from the dash portion toward a vehicle front side.

What is claimed is:

1. A vehicle front structure comprising:
a main framework that is die cast and that integrally includes a dash portion disposed at a vehicle front, partitioning between inside of a vehicle cabin and outside of the vehicle cabin, and a pair of right and left front pillar portions connected to both end portions of the dash portion in a vehicle width direction and extending in a vehicle up-down direction;
an outer panel that is disposed on an outer side of the main framework in the vehicle width direction and makes up an aesthetic surface, and that is also fastened to the main framework;
an instrument panel reinforcement extending in the vehicle width direction between the right and left front pillar portions in the vehicle cabin; and
a linking bracket that links the main framework and the instrument panel reinforcement.

2. The vehicle front structure according to claim 1, wherein:
the instrument panel reinforcement and the linking bracket are fastened in a vehicle front-rear direction; and
the main framework and the linking bracket are fastened in the vehicle width direction.

3. The vehicle front structure according to claim 1, wherein the main framework, the outer panel, and the linking bracket are fastened together by fasteners.

4. The vehicle front structure according to claim 3, wherein a collar member is disposed between the outer panel and the linking bracket.

5. The vehicle front structure according to claim 1, wherein the main framework includes a front side member portion extending to a forward side in a vehicle from the dash portion.
